(19) United States
(12) Patent Application Publication
(10) Pub. No.: US 2003/0193839 A1
(43) Pub. Date: Oct. 16, 2003

(54) Sonic data communications for small electronic devices

(76) Inventor: Manmohan L. Singh, Scottsdale, AZ (US)

Correspondence Address: The Halvorson Law Firm, Ste 1, 405 W. Southern Ave., Tempe, AZ, 85282, US

(21) Appl. No.: 10/122,881

(22) Filed: Apr. 11, 2002

(51) Int. Cl. H04B 1/02

(52) U.S. Cl. 367/137

(57) ABSTRACT

Presented is a device for transmitting data, for storage and use, to small electronic devices without need for additional devices being incorporated into one the communicating devices. Data is transmitted from a second device a to a first small electronic device. In transmitting the data, the second electronic device encodes the electronic data for sonic transmission. This is done by preparing a sound generating file that then drives the speaker of the second electronic device. A microphone of the first electronic device receives the sound waves/frequencies and then decrypts them into digital form. In a less preferred embodiment, the first electronic device may also encrypt electronic information for sound generation to drive the speaker of the first electronic device. Then, the microphone of the second electronic device receives the sound and decrypts it into its digital form and stores the decrypted information into a memory location.

### BACKGROUND OF THE INVENTION

1. The Field of the Invention

The present invention relates to small portable electronic devices. More specifically, the present invention relates to a method for using sound waves/frequencies for data communication to small electronic devices, and devices using the said method.

2. The Relevant Art

Small personal organizers, palm-size computers, combination phone/computers and other devices commonly known as personal digital assistants (PDAs) are in common use by the public. These devices are also known by many as “pen-based computers” because a user must use a stylus in order to enter data. Pen-based computers have grown in popularity for several reasons, chief amongst them being their small size and easy portability. Miniaturization of electronic components has made these devices increasingly powerful, versatile, and affordable.

These devices typically communicate with other devices either by direct electronic connection (a wire) or by photo-data transmission, such as using a LED or CRT. However, these data transmission means are not always available to small electronic devices or additional hardware must be incorporated into one, if not both, of the communicating devices.

Thus, there is a clear and present need for technology that allows for data transmission to small electronic devices that obviates the above discussed problems.

### SUMMARY OF THE INVENTION

It is an object of the present invention to provide a method for data transmission to small electronic devices using sonic waves/frequencies.

It is another object of the present invention to provide small electronic devices that utilize sonic waves/frequencies to receive data transmission.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C.§112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

The present invention will be readily understood by the following detailed description in conjunction with the accompanying drawings, with like reference numerals designating like elements.

FIG. 1. is a schematic of an embodiment of a small electronic device that uses sonic waves/frequencies to receive data.

### DETAILED DESCRIPTION OF THE PREFERRED EMBODIMENTS

The present invention useful for transmitting data, for storage and use, to small electronic devices without need for additional devices being incorporated into one the communicating devices.

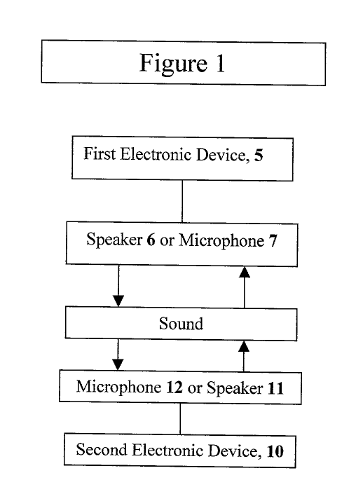

With reference to FIG. 1, a first small electronic device 5 is equipped with both a speaker 6 and a microphone 7. In certain embodiments, the speaker 6 and microphone 7 are one and the same. A second electronic device 10, such as a computer, Personal Digital Assistant, other small electronic device, or the like, is also equipped with a speaker 11 and a microphone 12. In certain embodiments, the speaker 11 and microphone 12 are one and the same.

In a preferred embodiment, data is transmitted from the second device 10 to the Data to be transferred from the first small electronic device 5. In transmitting the data, the second electronic device 10 encodes the electronic data for sonic transmission. This is done by preparing a sound generating file that then drives the speaker 11 of the second electronic device 10. The microphone 7 of the first electronic device 5 receives the sound waves/frequencies and then decrypts them into digital form. In a less preferred embodiment, the first electronic device 5 may also encrypt electronic information for sound generation to drive the speaker 6 of the first electronic device 5. Then, the microphone 12 of the second electronic device 10 receives the sound and decrypts it into its digital form and stores the decrypted information into a memory location. In the preferred embodiment small amounts of data are transmitted between the two devices, 5 and 10.

The sending and receiving of information is initiated by a user signaling the start of communication using any of the input mechanisms of the devices (however, the devices could also automatically initiate a send/receive or send only sequence by having one device listening for incoming information). Further, in a crowded room situation, some of the devices could optionally emit their information on regular interval or a frequency controlling manner. The devices may also be optionally listening for other devices in the vicinity. The device may then use the received data to make calculations and then possible raise and alert in case certain criteria are fulfilled. Such a technique will be useful for distinguishing large numbers of vendors and clients at a conference.

The information that this method can transmit is only limited by the memory requirements of the receiving device and include, but are not limited to, personal information, business information, recorded audio messages, and vendor contact/interest/profile information.

The sound frequency ranges include, but are not limited to sub-sonic, sonic, and ultrasonic, and still fall within the scope of the present invention. A “pleasant” sound may be included to indicate that data is being transferred when the actual data transfer occurs in the sub-sonic or ultra-sonic regions. Finally, the data transfer may be accomplished using any combination of the different frequency regions.

In order to prevent unwanted ambient noise interference, a very short range microphone type receiver on the receiving end may be utilized so that it effectively does not “hear’ ambient noise. In this embodiment, the units must be very close to each other, i.e. within the range determined by the microphone audio receiver specifications. This method may be used with or without the above described sonic connections.

The preferred embodiment(s) of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for transmitting data between two electronic device using sonic frequencies comprising:
a. providing first device equipped with a microphone;
b. providing a second device equipped with a speaker;
c. generating sound corresponding to the data being transmitted using the speaker of the second device;
d. receiving the sound corresponding to the data being transmitted using the microphone of the first device; and
e. storing the transmitted date received from the first device.

2. The method according to claim 1 wherein the sound is received using a short range microphone receiver.
